(19) United States
(12) Patent Application Publication
(10) Pub. No.: US 2022/0230105 A1
(43) Pub. Date: Jul. 21, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Jun HIOKI, Nagakute-shi (JP); Hideo HASEGAWA, Nagoya-shi (JP); Shintaro OSAKI, Handa-shi (JP); Hiroaki SASAKI, Nagoya-shi (JP); Yoshihiro UI, Nagoya-shi (JP)

(73) Assignee: TOYOTA JIDOSHA KABUSHIKI KAISHA, Toyota-shi (JP)

(21) Appl. No.: 17/568,107

(22) Filed: Jan. 4, 2022

(30) Foreign Application Priority Data
Jan. 19, 2021 (JP) 2021-006342

(51) Int. Cl. G06Q 10/06; G06F 3/14

(52) U.S. Cl. CPC G06Q 10/0631; G06F 3/14

(57) ABSTRACT

A control unit in an information processing apparatus acquires information on a congestion situation of a target facility, and acquires information on whether a user has a visit history to the target facility. Then, the control unit in the information processing apparatus determines, based on whose visit the target facility prioritizes between a visit of a first visitor and a visit of a second visitor, whether the user has the visit history to the target facility, and the information on the congestion situation of the target facility, a method of displaying the congestion situation of the target facility on a terminal. Here, the first visitor is a visitor who has not visited the target facility. Further, the second visitor is a visitor who has visited the facility. Further, the terminal is a terminal associated with the user.

### CROSS-REFERENCE TO RELATED APPLICATION

This application claims priority to Japanese Patent Application No. 2021-006342 filed on Jan. 19, 2021, incorporated herein by reference in its entirety.

### BACKGROUND

### 1. Technical Field

The present disclosure relates to an information processing apparatus, information processing method, and a non-transitory storage medium.

### 2. Description of Related Art

Japanese Unexamined Patent Application Publication No. 2016-164716 (JP 2016-164716 A) discloses an information processing apparatus. The information processing apparatus disclosed in JP 2016-164716 A specifies, based on a behavior history of a user, a priority of narrowing-down items that are used when the user narrows down facility information on a facility to be visited by the user. Then, the information processing apparatus outputs narrowing-down screen information that presents the user with the narrowing-down items according to the specified priority.

### SUMMARY

The present disclosure provides a technology for controlling congestion in a facility.

An information processing apparatus according to a first aspect of the present disclosure includes a control unit configured to acquire information on a congestion situation of a target facility, acquire information on whether a user has a visit history to the target facility, and determine a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

In the first aspect, when the target facility prioritizes a visit of the first visitor, the control unit may determine that a congestion level of the target facility displayed on the terminal is higher when the user has the visit history to the target facility than when the user does not have the visit history to the target facility, for the same congestion situation of the target facility.

In the first aspect, when the target facility prioritizes a visit of the second visitor, the control unit may determine that a congestion level of the target facility displayed on the terminal is lower when the user has the visit history to the target facility than when the user does not have the visit history to the target facility, for the same congestion situation of the target facility.

In the first aspect, the control unit may set a predetermined level based on whose visit the target facility prioritizes between the first visitor and the second visitor, and whether the user has the visit history to the target facility, and determine, when the congestion situation of the target facility is equal to or higher than the predetermined level, to cause the terminal to execute a specific display on the target facility.

In the first aspect, when the target facility prioritizes the visit of the first visitor, the control unit may set the predetermined level to be lower when the user has the visit history to the target facility than when the user does not have the visit history to the target facility.

In the first aspect, when the target facility prioritizes the visit of the second visitor, the control unit may set the predetermined level to be higher when the user has the visit history to the target facility than when the user does not have the visit history to the target facility.

In the first aspect, the specific display may be hiding the target facility from a map displayed on the terminal.

In the first aspect, the specific display may be displaying a predetermined display indicating that the target facility is congested.

An information processing method according to a second aspect of the present disclosure is an information processing method executed by a computer. The information processing method includes a step of acquiring information on a congestion situation of a target facility, a step of acquiring information on whether a user has a visit history to the target facility, and a step of determining a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

In the second aspect, when the target facility prioritizes a visit of the first visitor, a congestion level of the target facility displayed on the terminal may be determined to be higher when the user has the visit history to the target facility than when the user does not have the visit history to the target facility, for the same congestion situation of the target facility.

In the second aspect, when the target facility prioritizes a visit of the second visitor, a congestion level of the target facility displayed on the terminal may be determined to be lower when the user has the visit history to the target facility than when the user does not have the visit history to the target facility, for the same congestion situation of the target facility.

In the second aspect, the information processing method may further include a step of setting a predetermined level based on whose visit the target facility prioritizes between the first visitor and the second visitor, and whether the user has the visit history to the target facility. When the congestion situation of the target facility is equal to or higher than the predetermined level, the terminal is determined to execute a specific display on the target facility.

In the second aspect, when the target facility prioritizes the visit of the first visitor, the predetermined level may be set to be lower when the user has the visit history to the target facility than when the user does not have the visit history to the target facility.

In the second aspect, when the target facility prioritizes the visit of the second visitor, the predetermined level may be set to be higher when the user has the visit history to the target facility than when the user does not have the visit history to the target facility.

In the second aspect, the specific display may be hiding the target facility from a map displayed on the terminal.

In the second aspect, the specific display may be displaying a predetermined display indicating that the target facility is congested.

A non-transitory storage medium according to a third aspect of the present disclosure is a non-transitory storage medium storing a program that causes a computer to execute an information processing method. The information processing method includes a step of acquiring information on a congestion situation of a target facility, a step of acquiring information on whether a user has a visit history to the target facility, and a step of determining a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

In the third aspect, when the target facility prioritizes a visit of the first visitor, in the information processing method, a congestion level of the target facility displayed on the terminal may be determined to be higher when the user has the visit history to the target facility than when the user does not have the visit history to the target facility, for the same congestion situation of the target facility.

In the third aspect, when the target facility prioritizes a visit of the second visitor, in the information processing method, a congestion level of the target facility displayed on the terminal may be determined to be lower when the user has the visit history to the target facility than when the user does not have the visit history to the target facility, for the same congestion situation of the target facility.

In the third aspect, the information processing method may further include a step of setting a predetermined level based on whose visit the target facility prioritizes between the first visitor and the second visitor, and the information on whether the user has the visit history to the target facility. When the congestion situation of the target facility is equal to or higher than the predetermined level, the terminal may be determined to execute a specific display on the target facility.

With each aspect of the present aspect, it is possible to restrict congestion of a facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a search system;

FIG. 2 is a block diagram schematically illustrating an example of a functional configuration of a user terminal and a search server;

FIG. 3 is an example of a table configuration of facility information;

FIG. 4 is an example of a table configuration of history information;

FIG. 5 is a diagram illustrating an example of a table configuration of correspondence information;

FIG. 6 is a flowchart of first processing;

FIG. 7A is a diagram illustrating an example of displaying a congestion level on the user terminal when the target facility prioritizes a first visitor and a user does not have a visit history to the target facility;

FIG. 7B is a diagram illustrating another example of displaying the congestion level on the user terminal when the target facility prioritizes the first visitor and the user has the visit history to the target facility;

FIG. 8 is a diagram illustrating an example of a predetermined level set by a control unit in the search server; and

FIG. 9 is a flowchart of second processing.

### DETAILED DESCRIPTION OF EMBODIMENTS

An information processing apparatus according to a first aspect of the present disclosure presents a user with information on a congestion situation of a target facility. A control unit in the information processing apparatus according to the first aspect of the present disclosure acquires information on the congestion situation of the target facility. Here, it is assumed that the target facility prioritizes a visit of one of a first visitor who has never visited the target facility and a second visitor who has visited the target facility. Therefore, the control unit in the information processing apparatus acquires information on whether a user has a visit history to the target facility. Then, the control unit determines a method of displaying the congestion situation of the target facility on the terminal based on whose visit to prioritize between the first visitor and the second visitor, whether the user has the visit history to the target facility, and information on the congestion situation of the target facility. Here, the terminal is a terminal associated with the user.

As described above, in a search system 1, a different display method is determined depending on whose visit the target facility prioritizes between the first visitor and the second visitor, and whether the user is the first visitor or the second visitor. As such, the terminal can display the congestion situation of the target facility using a different display method depending on whether the user is a visitor whose visit the target facility prioritizes. As a result, when the user is not a visitor whose visit the target facility prioritizes, the terminal can display the congestion situation of the target facility using a display method whereby a visit of the user is restricted, as compared with when the user is a visitor whose visit the target facility prioritizes. As such, when the user is not a visitor whose visit the target facility prioritizes, the visit of the user to the target facility is restricted. In this manner, it is possible to restrict the congestion of the target facility.

Hereinafter, specific embodiments of the present disclosure will be described with reference to the drawings. Unless otherwise specified, the dimensions, materials, shapes, relative arrangements, and the like of the components described in the present embodiment are not intended to limit the technical scope of the present disclosure.

### First Embodiment

System Overview

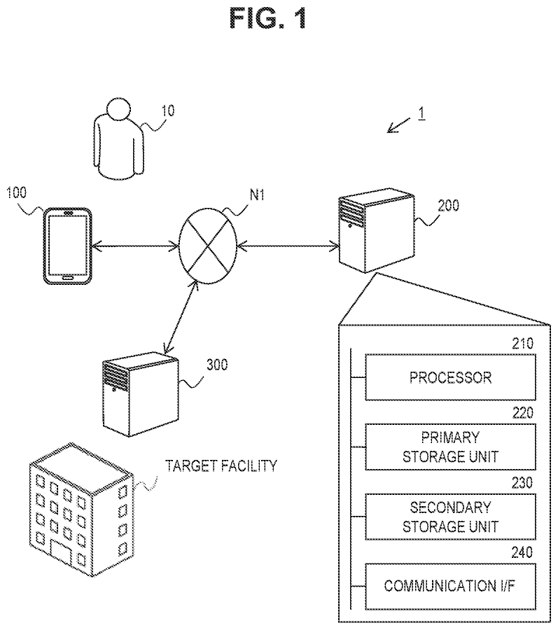

The search system 1 in the present embodiment will be described with reference to FIG. 1. FIG. 1 is a diagram illustrating a schematic configuration of the search system 1. The search system 1 includes a user terminal 100, a search server 200, and a facility server 300. In the search system 1, the user terminal 100, the search server 200, and the facility server 300 are connected to each other via a network N1. For the network N1, for example, a wide area network (WAN), which is a world-wide public communication network, such as the Internet, or a telephone communication network, such as a mobile phone, may be employed.

User Terminal 100

The user terminal 100 is a terminal associated with a user 10. In the present embodiment, the user terminal 100 is a terminal, such as a smartphone, a tablet computer, or a wearable terminal used by the user 10. The user 10 searches for a facility using the user terminal 100. Then, the user terminal 100 displays information on a target facility as a search result from the search server 200. The target facility is a facility specified by the search server 200 as a search result of the facility searched for by the user 10. Specifically, the user terminal 100 superimposes a location and a congestion level of the target facility as search results on a map on the user terminal 100 and displays them. In the present embodiment, the user terminal 100 corresponds to a “terminal” according to the present disclosure.

Facility Server 300

The facility server 300 acquires a congestion situation of the target facility. In the present embodiment, the congestion situation of the target facility acquired by the facility server 300 is indicated by the number of people per unit area in the target facility.

As a method of acquiring the congestion situation of the target facility by the facility server 300, a well-known method can be employed. For example, the facility server 300 acquires the congestion situation of the target facility based on a moving image captured by a camera provided in the target facility. Alternatively, for example, the facility server 300 may count the entry/exit of people detected by a sensor provided at an entrance/exit of the target facility, and acquire the congestion situation of the target facility based on the counted number of people and an area of the target facility. The facility server 300 transmits the acquired congestion situation of the target facility to the search server 200 as congestion information.

Search Server 200

The search server 200 presents locations of various facilities and their congestion levels. Here, depending on the facility, there is a case where a visit of a visitor who has never visited the facility (hereinafter, sometimes referred to as a “first visitor”) is prioritized. Further, depending on the facility, there is a case where a visit of a visitor who has visited the facility (hereinafter, sometimes referred to as a “second visitor”) is prioritized. In other words, it is assumed that each facility prioritizes a visit of one of the first visitor and the second visitor. Here, whose visit each facility prioritizes between the first visitor and the second visitor is determined in advance by a manager who manages each facility. Therefore, the search server 200 determines the congestion level of the target facility displayed on the user terminal 100 based on whose visit the target facility prioritizes between the first visitor and the second visitor, whether the user 10 has the visit history to the target facility, and the congestion situation of the target facility. Details of the method of determining the congestion level of the target facility will be described below.

The search server 200 includes a computer having a processor 210, a primary storage unit 220, a secondary storage unit 230, and a communication interface (communication I/F) 240. The processor 210 may be, for example, a central processing unit (CPU) or a digital signal processor (DSP). The primary storage unit 220 may be, for example, a random access memory (RAM). The secondary storage unit 230 may be, for example, a read-only memory (ROM). Further, the secondary storage unit 230 may be, for example, a hard disk drive (HDD) or a disc recording medium, such as a CD-ROM, a DVD disc, or a Blu-ray disc. Further, the secondary storage unit 230 may be a removable medium (a portable storage medium). Here, an example of the removable medium includes a USB memory or an SD card. The communication I/F 240 may be, for example, a local area network (LAN) interface board or a wireless communication circuit for wireless communication.

In the search server 200, the secondary storage unit 230 stores an operating system (OS), various programs, various information tables, and the like. Further, in the search server 200, the processor 210 can implement various functions as described below by loading the program stored in the secondary storage unit 230 onto the primary storage unit 220 and executing the program. However, some or all of the functions of the search server 200 may be implemented by a hardware circuit, such as an ASIC or an FPGA. The search server 200 does not necessarily have to be implemented by a single physical configuration, and may be composed of a plurality of computers that cooperate with each other. In the same manner as the search server 200, the facility server 300 also includes a computer. Further, in the present embodiment, the search server 200 corresponds to an “information processing apparatus” according to the present disclosure.

Functional Configuration

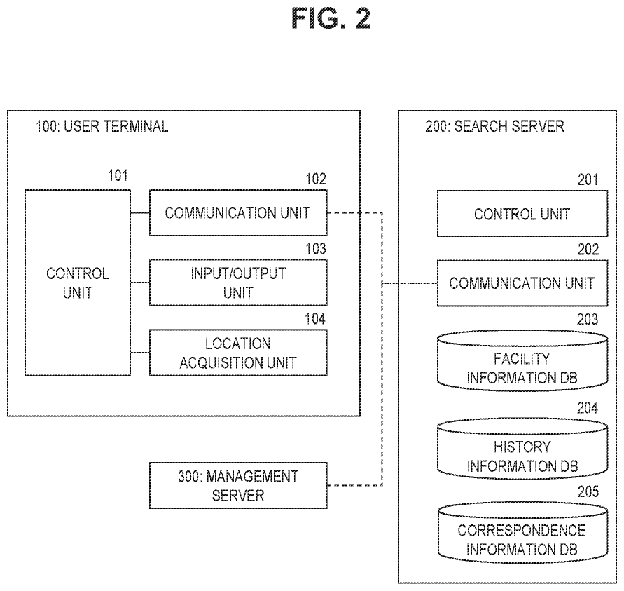

Next, functional configurations of the user terminal 100 and the search server 200 that compose the search system 1 according to the present embodiment will be described with reference to FIGS. 2 to 5. FIG. 2 is a block diagram schematically illustrating examples of the functional configurations of the user terminal 100 and the search server 200.

User Terminal 100

The user terminal 100 includes a control unit 101, a communication unit 102, an input/output unit 103, and a location acquisition unit 104. The control unit 101 has a function of executing arithmetic processing for controlling the user terminal 100. The control unit 101 can be implemented by the processor in the user terminal 100. The communication unit 102 has a function of connecting the user terminal 100 to the network N1. The communication unit 102 can be implemented by the communication I/F in the user terminal 100.

The input/output unit 103 has a function by which the user 10 inputs various pieces of information to the user terminal 100. Further, the input/output unit 103 has a function of displaying various pieces of information to the user 10. The input/output unit 103 can be implemented by a touch panel on the user terminal 100. When searching for the location of the facility, the user 10 inputs information for searching for the facility to the input/output unit 103 (hereinafter, sometimes referred to as “search information”). The search information may be information such as a category to which the facility belongs. The category to which the facility belongs may be a category, such as a “restaurant” or a “temple”. The control unit 101 transmits the search information to the search server 200 via the communication unit 102.

The control unit 101 transmits the search information to the search server 200 via the communication unit 102, and receives the result information from the search server 200. The result information includes the location and the congestion level of the target facility. Upon receiving the result information, the control unit 101 superimposes the location and the congestion level of the target facility on the map displayed by the input/output unit 103 and causes the input/output unit 103 to display them. As such, the user 10 can grasp the location and the congestion level of the target facility.

The location acquisition unit 104 has a function of acquiring a current location of the user terminal 100 (that is, the current location of the user 10). The location acquisition unit 104 can be implemented by a GPS sensor in the user terminal 100. The control unit 101 transmits, to the search server 200, information that includes the current location of the user 10 (hereinafter, sometimes referred to as “location information”) acquired by the location acquisition unit 104 via the communication unit 102.

Search Server 200

The search server 200 includes a control unit 201, a communication unit 202, a facility information database 203 (a facility information DB 203), a history information database 204 (a history information DB 204), and a correspondence information database 205 (a correspondence information DB 205). The control unit 201 has a function of executing arithmetic processing for controlling the search server 200. The control unit 201 can be implemented by the processor 210 in the search server 200. The communication unit 202 has a function of connecting the search server 200 to the network N1. The communication unit 202 can be implemented by the communication I/F 240 in the search server 200.

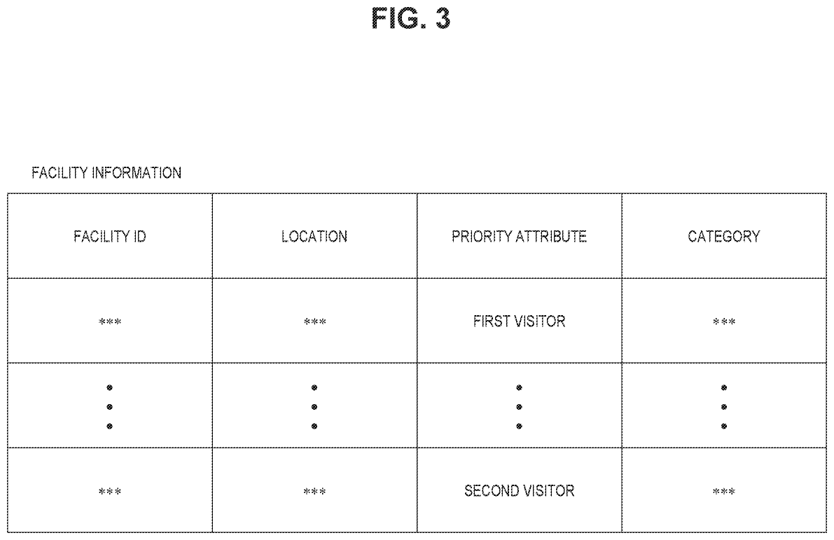

The facility information DB 203 is used for storing the facility information. The facility information includes information on a location of each of a plurality of facilities. The facility information DB 203 can be implemented by the secondary storage unit 230 in the search server 200. FIG. 3 is an example of a table configuration of the facility information. As illustrated in FIG. 3, the facility information has a facility ID field, a location field, a priority attribute field, and a category field. An identifier (the facility ID) used for identifying each facility is entered into the facility ID field. The location of the facility corresponding to the facility ID entered into the facility ID field is entered into the location field. As the location of the facility entered into the location field, for example, the latitude and longitude of the facility are entered. An attribute of a visitor whose visit each facility prioritizes is entered into the priority attribute field. In other words, whose visit the facility prioritizes between the first visitor and the second visitor is entered into the priority attribute field. The category to which each facility belongs is entered into the category field.

The history information DB 204 is used for storing history information. The history information is information on the visit history of the user 10 to the facility in the past. The history information DB 204 can be implemented by the secondary storage unit 230 in the search server 200. The control unit 201 receives the location information from the user terminal 100 via the communication unit 202. Based on a transition of the current location of the user 10 included in the location information, the control unit 201 specifies the facility visited by the user 10. Specifically, when the current location of the user 10 exists in a specific facility for a predetermined time or longer, the control unit 201 specifies the specific facility as the facility visited by the user 10. The control unit 201 stores information on the specified facility in the history information DB 204.

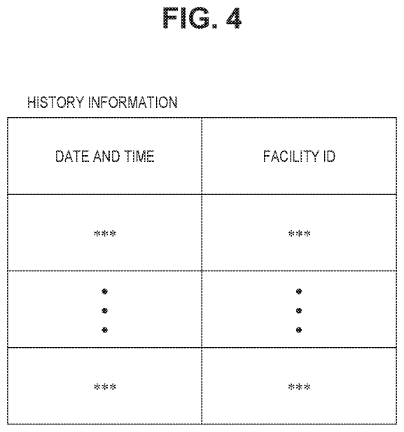

FIG. 4 is an example of a table configuration of the history information. As illustrated in FIG. 4, the history information has a date and time field and a facility ID field. A date and time at which the user 10 visited the facility is entered into the date and time field. The identifier (the facility ID) used for specifying the facility visited by the user 10 is entered into the facility ID field.

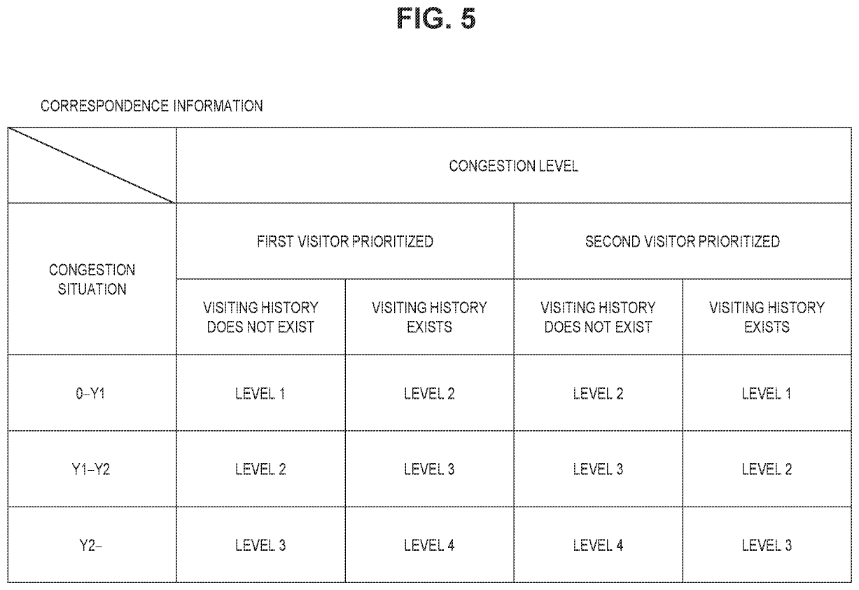

The correspondence information DB 205 is used for storing the correspondence information. In the present embodiment, the correspondence information is the information on a correspondence between the congestion situation for determining the congestion level and the congestion level. The correspondence information DB 205 can be implemented by the secondary storage unit 230 in the search server 200. FIG. 5 is a diagram illustrating an example of a table configuration of the correspondence information. As illustrated in FIG. 5, the correspondence information has a congestion situation field and a congestion level field. A range of the number of people per unit area in the facility is entered into the congestion situation field. When “Y1-Y2” is entered into the congestion situation field, it means that the number of people per unit area in the facility is in the range of Y1 or more and less than Y2. Further, when, for example, “Y2-” is entered into the congestion situation field, it means that the number of people per unit area is in the range of Y2 or more. In other words, a range of 0 or more and less than Y1, the range of Y1 or more and less than Y2, and the range of Y2 or more are entered into the congestion situation field as the ranges of the number of people per unit area in the facility.

The congestion level corresponding to each congestion situation is entered into the congestion level field. Here, the congestion level indicates that the facilities are congested in the order of level 1 to level 4. Further, in the case where the facility prioritizes the visit of the first visitor, the congestion level when the user 10 does not have the visit history to the facility and the congestion level when the user 10 has the visit history to the facility are entered into the congestion level field. Further, in the case where the facility prioritizes the visit of the second visitor, the congestion level when the user 10 does not have the visit history to the facility and the congestion level when the user 10 has the visit history to the facility are entered into the congestion level field.

When the facility prioritizes the visit of the first visitor, a higher congestion level is entered into the congestion level field when the user 10 has the visit history to the facility than when the user 10 does not have the visit history to the facility, for the same congestion situation. In other words, when the facility prioritizes the visit of the first visitor, the congestion level indicating that the facility is more congested is entered into the congestion level field when the user 10 has the visit history to the facility than when the user 10 does not have the visit history to the facility. For example, it is assumed that the facility prioritizes the visit of the first visitor and the number of people per unit area in the facility is “Y1-Y2”. In this case, when the user 10 has the visit history to the facility, “level 3” is entered into the congestion level field. On the other hand, in this case, when the user 10 does not have the visit history to the facility, “level 2” is entered into the congestion level field. As such, a higher congestion level is entered into the congestion level field when the user 10 has the visit history to the facility than when the user 10 does not have the visit history to the facility.

On the other hand, when the facility prioritizes the visit of the second visitor, a lower congestion level is entered into the congestion level field when the user 10 has the visit history to the facility than when the user 10 does not have the visit history to the facility, for the same congestion situation.

The control unit 201 receives the search information from the user terminal 100 via the communication unit 202. The control unit 201 specifies the target facility based on the search information. Specifically, the control unit 201 specifies, as a target facility, a facility in the facility information stored in the facility information DB 203, of which a category matches the category of the facility in the search information. Then, the control unit 201 acquires a location of the target facility from the facility information stored in the facility information DB 203. Further, the control unit 201 acquires a priority attribute of the target facility. In other words, the control unit 201 acquires the location of the target facility and whose visit the target facility prioritizes between the first visitor and the second visitor.

Further, the control unit 201 acquires whether the user 10 has the visit history to the target facility based on the history information stored in the history information DB 204. Specifically, the control unit 201 acquires whether the user 10 has the visit history to the target facility based on whether the target facility is included in the history information.

Further, the control unit 201 receives the congestion information from the facility server 300 via the communication unit 202. The control unit 201 determines the congestion level based on the priority attribute of the target facility, whether the user 10 has the visit history to the target facility, and the congestion situation of the target facility in the congestion information. For example, it is assumed that the priority attribute of the target facility is the first visitor, the user 10 has the visit history to the target facility, and the number of people per unit area indicating the congestion situation is “Y1-Y2”. In this case, the control unit 201 determines the congestion level to be “level 3” (see FIG. 5).

Upon determining the congestion level, the control unit 201 generates result information including the location of the target facility and the determined congestion level. Then, the control unit 201 transmits the result information to the user terminal 100 via the communication unit 202.

First Processing

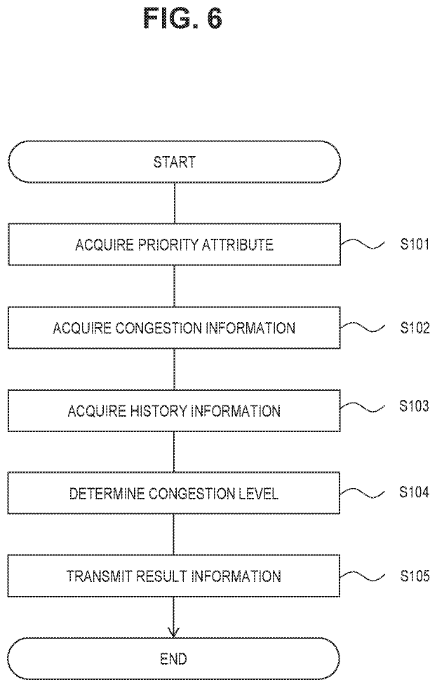

Next, in a search system 1 according to the present embodiment, first processing executed by the control unit 201 in the search server 200 will be described with reference to FIG. 6. FIG. 6 is a flowchart of the first processing. Here, the first processing is for determining the congestion level and transmitting the result information to the user terminal 100. The first processing is started when the search server 200 receives the search information from the user terminal 100.

In the first processing, first, in S101, the priority attribute of the target facility is acquired from the facility information stored in the facility information DB 203. Further, in S102, the congestion information received from the facility server 300 is acquired. Further, in S103, the history information is acquired from the history information DB 204. Next, in S104, the congestion level is determined based on the priority attribute of the target facility, whether the user 10 has the visit history to the target facility, and the congestion situation of the target facility in the congestion information. Then, in S105, the result information including the location and the congestion level of the target facility is generated and transmitted to the user terminal 100. Then, the first processing ends.

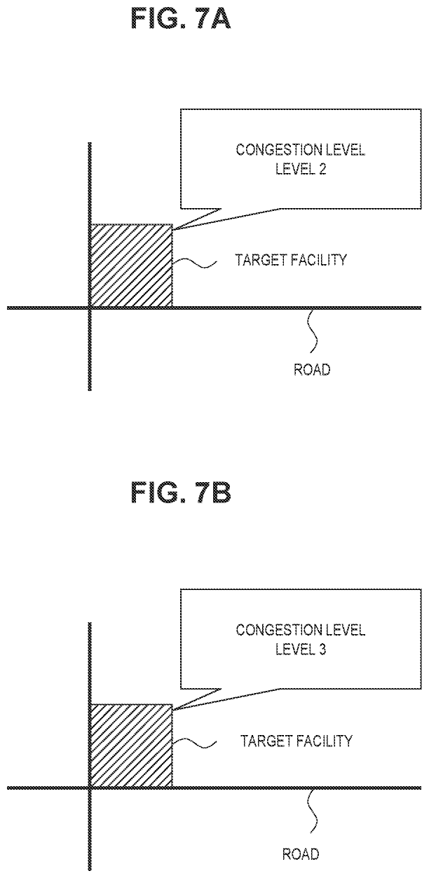

Upon receiving the result information, the user terminal 100 superimposes the location and the congestion level of the target facility on the map displayed on the user terminal 100 and displays them. Here, it is assumed that the target facility prioritizes the visit of the first visitor. FIG. 7A is a diagram illustrating an example of displaying a congestion level on the user terminal 100 when the target facility prioritizes the first visitor and the user 10 does not have the visit history to the target facility. Further, FIG. 7B is a diagram illustrating another example of displaying the congestion level on the user terminal 100 when the target facility prioritizes the first visitor and the user 10 has the visit history to the target facility.

In the examples illustrated in FIGS. 7A and 7B, the congestion levels displayed on the user terminal 100 when the number of people per unit area in the target facility indicating the congestion situation of the target facility is “Y1-Y2” are illustrated. In this case, as illustrated in FIG. 7A, when the user 10 does not have the visit history to the target facility, the congestion level of the target facility displayed on the user terminal 100 is “level 2”. Further, in this case, as illustrated in FIG. 7B, when the user 10 has the visit history to the target facility, the congestion level of the target facility displayed on the user terminal 100 is “level 3”. In this manner, a higher congestion level is displayed on the user terminal 100 when the user 10 has the visit history to the target facility than when the user 10 does not have the visit history to the target facility, for the same congestion situation.

On the other hand, when the target facility is a facility that prioritizes the visit of the second visitor, a lower congestion level is displayed on the user terminal 100 when the user 10 has the visit history to the target facility than when the user 10 does not have the visit history to the target facility, for the same congestion situation.

As described above, the search system 1 determines the congestion level of the target facility based on whose visit the target facility prioritizes between the first visitor and the second visitor, whether the user 10 has the visit history to the target facility, and the congestion situation of the target facility. As such, when the target facility prioritizes the visit of the first visitor, a higher congestion level is displayed on the user terminal 100 when the user 10 has the visit history to the target facility than when the user 10 does not have the visit history to the target facility, for the same congestion situation. As such, it is easier to restrict the user from visiting the target facility when the user 10 has the visit history to the target facility than when the user 10 does not have the visit history to the target facility.

Further, when the target facility prioritizes the visit of the first visitor, a lower congestion level is displayed on the user terminal 100 when the user 10 does not have the visit history to the target facility than when the user 10 has the visit history to the target facility, for the same congestion situation. For this reason, it is more difficult to restrict the user from visiting the target facility when the user 10 does not have the visit history to the target facility than when the user 10 has the visit history to the target facility.

Further, it is assumed that the target facility prioritizes the visit of the second visitor. In this case, in the same manner as when the target facility prioritizes the first visitor, it is also possible to restrict the user 10 who does not have the visit history to the target facility from visiting the target facility without restricting the user 10 who has the visit history to the target facility from visiting the target facility.

In this manner, it is possible for the search system 1 to restrict the visitor whose visit is not prioritized between the first visitor and the second visitor from visiting the target facility without restricting the visitor whose visit is prioritized from visiting the target facility. In this manner, it is possible to restrict the congestion of the target facility.

### Modified Example

In the present embodiment, the user terminal 100 superimposes the congestion level of the target facility on the map and displays it. However, the user terminal 100 does not necessarily have to superimpose the congestion level of the target facility on the map and display it. For example, the user terminal 100 may only display the congestion level of the target facility as the search result. In this manner, it is also possible to restrict the congestion of the target facility.

Further, in the present embodiment, the result information includes the location and the congestion level of the target facility. However, the result information may include information other than the location and the congestion level of the target facility. The result information may include, for example, information on equipment of the target facility or a service and the like presented in the target facility.

Further, in the present embodiment, the number of people per unit area in the target facility is received from the facility server 300 as the congestion information. However, the congestion information does not necessarily have to be the number of people per unit area in the target facility. As the congestion information, well-known information indicating the congestion situation of the target facility can be employed. Further, the search server 200 does not necessarily have to receive the congestion information from the facility server 300. The search server 200 may acquire the congestion situation of the target facility by itself based on, for example, a moving image of a camera and the like provided in the target facility.

Further, in the present embodiment, the search server 200 may specify a plurality of target facilities based on the search information. In this case, the search server 200 acquires the congestion situation of each target facility from the congestion information of the specified plurality of target facilities. Then, the search server 200 determines the congestion level of each target facility based on the priority attribute of each target facility, the visit history of the user 10 to each target facility, and the congestion information of each target facility. Then, the search server 200 transmits the result information including the location and the congestion level of each target facility to the user terminal 100. The user terminal 100 that has received the result information superimposes the location and the congestion level of each target facility on the map displayed on the user terminal 100 and displays them.

### Second Embodiment

In the present embodiment, when the congestion level of the target facility is equal to or higher than a predetermined level, the search server 200 determines to cause the user terminal 100 to execute a specific display on the target facility on the map displayed on the user terminal 100. In the present embodiment, the specific display is hiding the target facility from the map displayed on the user terminal 100. Hereinafter, only the points different from those of the first embodiment will be described.

Search Server 200

The control unit 201 in the search server 200 sets the predetermined level of the congestion situation of the target facility based on whose visit the target facility prioritizes between the first visitor and the second visitor, and whether the user 10 has the visit history to the target facility. In the present embodiment, the predetermined level is a level of the number of people per unit area in the target facility.

It is assumed that the target facility prioritizes the visit of the first visitor. In this case, the control unit 201 sets the predetermined level to be lower when the user 10 has the visit history to the target facility than when the user 10 does not have the visit history to the target facility. On the other hand, it is assumed that the target facility prioritizes the visit of the second visitor. In this case, the control unit 201 sets the predetermined level to be higher when the user 10 has the visit history to the target facility than when the user 10 does not have the visit history to the target facility.

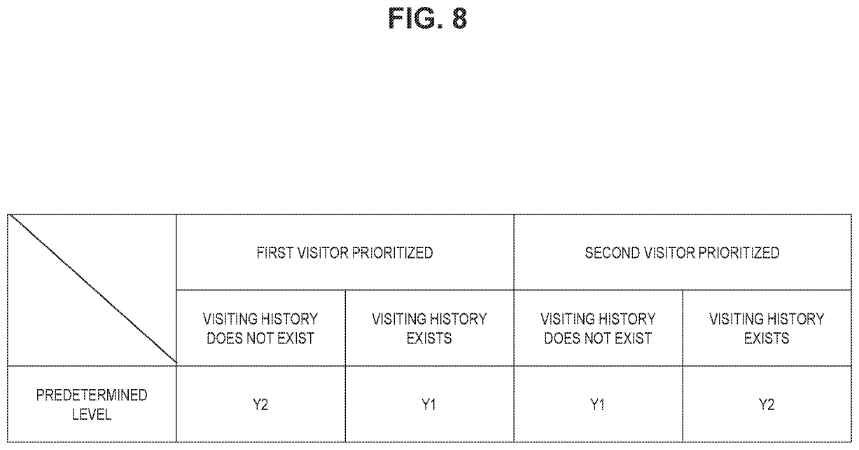

FIG. 8 is a diagram illustrating an example of the predetermined level set by the control unit 201. As illustrated in FIG. 8, as the predetermined level when the target facility prioritizes the visit of the first visitor, the control unit 201 sets a different predetermined level depending on whether or not the user 10 has the visit history to the target facility. Specifically, when the user 10 does not have the visit history to the target facility, the control unit 201 sets “Y2” as the predetermined level. On the other hand, when the user 10 has the visit history to the target facility, the control unit 201 sets “Y1” as the predetermined level. Here, among “Y1” and “Y2”, “Y1” means that the number of people per unit area in the target facility is smaller (that is, the level of congestion situation is lower) than that of “Y2”.

As illustrated in FIG. 8, as the predetermined level when the target facility prioritizes the visit of the second visitor, the control unit 201 sets a different predetermined level depending on whether or not the user 10 has the visit history to the target facility. Specifically, when the user 10 does not have the visit history to the target facility, the control unit 201 sets “Y1” as the predetermined level. On the other hand, when the user 10 has the visit history to the target facility, the control unit 201 sets “Y2” as the predetermined level.

When the congestion situation of the target facility is equal to or higher than the predetermined level, the control unit 201 generates information for causing the user terminal 100 to execute the specific display on the target facility on the map displayed on the user terminal 100 via the communication unit 202 (hereinafter, sometimes referred to as “specific display information”), and transmits the information to the user terminal 100. Here, the specific display information is information indicating that the target facility displayed on the user terminal 100 does not exist.

Second Processing

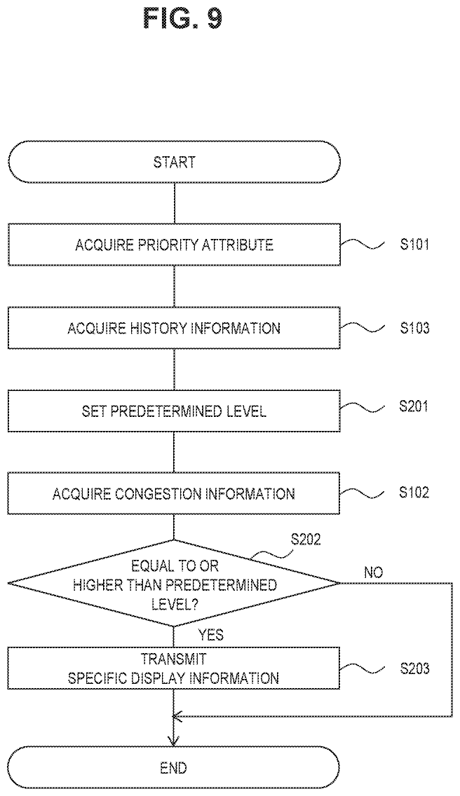

Next, in the search system 1 according to the present embodiment, second processing executed by the control unit 201 in the search server 200 will be described with reference to FIG. 9. FIG. 9 is a flowchart of the second processing. Here, the second processing is for setting the predetermined level and transmitting the specific display information to the user terminal 100. The second processing is started when the search server 200 receives the search information from the user terminal 100.

In the second processing, first, in the processes of S101 and S103, the priority attribute of the target facility and the history information of the user 10 to the target facility are acquired. Next, in S201, the predetermined level is set based on the priority attribute of the target facility and whether the user 10 has the visit history to the target facility. Next, in S102, the congestion information is acquired. Next, in S202, whether the congestion situation of the target facility is equal to or higher than the predetermined level is determined. In S202, when the determination is negative, the congestion situation of the target facility is lower than the predetermined level, and thus the user terminal 100 does not execute the specific display. Then, the second processing ends.

On the other hand, in S202, when the determination is positive, the congestion situation of the target facility is equal to or higher than the predetermined level, and thus the user terminal 100 executes the specific display. For this reason, in S203, the specific display information is transmitted to the user terminal 100. In this case, upon receiving the specific display information, the user terminal 100 superimposes, for example, a message indicating that the target facility does not exist on the displayed map and displays it. In other words, the user terminal 100 that has received the specific display information hides the target facility from the map displayed on the user terminal 100.

As described above, in the search system 1, when the congestion situation of the target facility is equal to or higher than the predetermined level, the specific display information is transmitted to the user terminal 100. Here, it is assumed that the target facility prioritizes the visit of the first visitor. In this case, the predetermined level is set to be lower when the user 10 has the visit history to the target facility than when the user 10 does not have the visit history to the target facility. As such, it is easier to transmit the specific display information to the user terminal 100 when the user 10 has the visit history to the target facility than when the user 10 does not have the visit history to the target facility. For this reason, it is easier to restrict the user 10 who has the visit history to the target facility from visiting the target facility than the user 10 who does not have the visit history to the target facility. Further, when the target facility prioritizes the second visitor as well, it is easier to restrict the user 10 who does not have the visit history to the target facility from visiting the target facility than the user 10 who has the visit history to the target facility.

In this manner, it is possible for the search system 1 to restrict the visitor whose visit the target facility does not prioritize between the first visitor and the second visitor from visiting the target facility without restricting the visitor whose visit the target facility prioritizes from visiting the target facility. In this manner, it is possible to restrict the congestion of the target facility.

### Modified Example

In the present embodiment, the specific display is hiding the target facility from the map displayed on the user terminal 100. However, the specific display does not necessarily have to hide the target facility from the map displayed on the user terminal 100. The specific display may be, for example, displaying, by the user terminal 100, a predetermined display indicating that the target facility is congested on the map. The predetermined display may be, for example, a message indicating that the target facility is congested. In this manner, it is also possible to restrict the congestion of the target facility.

Further, in the present embodiment, the search server 200 may specify a plurality of target facilities based on the search information. In this case, the search server 200 sets the predetermined level for each target facility based on the priority attribute of each target facility and the visit history of the user 10 to each target facility. Then, the search server 200 determines whether the congestion situation of each target facility is equal to or higher than the predetermined level set for each target facility. Then, the search server 200 generates the result information on the target facility other than the target facility in which the congestion situation of the target facility is equal to or higher than the predetermined level set for the target facility (hereinafter, sometimes referred to as a “hidden facility”) from among the plurality of target facilities, and transmits the result information to the user terminal 100. The user terminal 100 that has received the result information superimposes the target facility other than the hidden facility from among the plurality of target facilities on the map, and displays it. In other words, the user terminal 100 does not display the hidden facility. In this manner, when the search server 200 transmits the result information that does not include the hidden facility, it is possible to cause the user terminal 100 to execute the specific display on the hidden facility. As a result, it is possible to restrict the congestion of the target facility.

### Other Embodiments

The above-described embodiments are merely examples, and the present disclosure may be appropriately modified and implemented without departing from the gist thereof. Further, the processes and the elements described in the present disclosure can be freely combined and implemented as long as no technical contradiction arises.

Further, the processing described as being executed by one device may be executed in a shared manner by a plurality of devices. Alternatively, the processing described as being executed by different devices may be executed by one device. In a computer system, the hardware configuration (the server configuration) that implements each function can be flexibly changed.

The present disclosure can also be implemented by supplying a computer program having the functions described in the above embodiments to a computer, and reading and executing the program by one or more processors included in the computer. Such a computer program may be provided to the computer by a non-transitory computer-readable storage medium that can be connected to the computer system bus, or provided to the computer via the network. Examples of the non-transitory computer-readable storage medium include any type of disk, such as a magnetic disk (a Floppy® disk, an HDD, and the like) and an optical disk (a CD-ROM, a DVD disc, a Blu-ray disc, or the like), a ROM, a RAM, an EPROM, an EEPROM, a magnetic card, a flash memory, or any type of medium, such as an optical card, suitable for storing electronic commands.

What is claimed is:

1. An information processing apparatus comprising:
a control unit configured to:
acquire information on a congestion situation of a target facility;
acquire information on whether a user has a visit history to the target facility; and
determine a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

2. The information processing apparatus according to claim 1, wherein the control unit is configured to, when the target facility prioritizes a visit of the first visitor, determine that a congestion level of the target facility displayed on the terminal is higher when the user has the visit history to the target facility than when the user does not have the visit history to the target facility, for the same congestion situation of the target facility.

3. The information processing apparatus according to claim 1, wherein the control unit is configured to, when the target facility prioritizes a visit of the second visitor, determine that a congestion level of the target facility displayed on the terminal is lower when the user has the visit history to the target facility than when the user does not have the visit history to the target facility, for the same congestion situation of the target facility.

4. The information processing apparatus according to claim 1, wherein the control unit is configured to:
set a predetermined level based on whose visit the target facility prioritizes between the first visitor and the second visitor, and whether the user has the visit history to the target facility; and
determine, when the congestion situation of the target facility is equal to or higher than the predetermined level, to cause the terminal to execute a specific display on the target facility.

5. The information processing apparatus according to claim 4, wherein the control unit is configured to, when the target facility prioritizes the visit of the first visitor, set the predetermined level to be lower when the user has the visit history to the target facility than when the user does not have the visit history to the target facility.

6. The information processing apparatus according to claim 4, wherein the control unit is configured to, when the target facility prioritizes the visit of the second visitor, set the predetermined level to be higher when the user has the visit history to the target facility than when the user does not have the visit history to the target facility.

7. The information processing apparatus according to claim 4, wherein the specific display is hiding the target facility from a map displayed on the terminal.

8. The information processing apparatus according to claim 4, wherein the specific display is displaying a predetermined display indicating that the target facility is congested.

9. An information processing method executed by a computer, the information processing method comprising:
acquiring information on a congestion situation of a target facility;
acquiring information on whether a user has a visit history to the target facility; and
determining a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

10. The information processing method according to claim 9, wherein, when the target facility prioritizes a visit of the first visitor, a congestion level of the target facility displayed on the terminal is determined to be higher when the user has the visit history to the target facility than when the user does not have the visit history to the target facility, for the same congestion situation of the target facility.

11. The information processing method according to claim 9, wherein, when the target facility prioritizes a visit of the second visitor, a congestion level of the target facility displayed on the terminal is determined to be lower when the user has the visit history to the target facility than when the user does not have the visit history to the target facility, for the same congestion situation of the target facility.

12. The information processing method according to claim 9, further comprising:
setting a predetermined level based on whose visit the target facility prioritizes between the first visitor and the second visitor, and whether the user has the visit history to the target facility, wherein
when the congestion situation of the target facility is equal to or higher than the predetermined level, the terminal is determined to execute a specific display on the target facility.

13. The information processing method according to claim 12, wherein, when the target facility prioritizes the visit of the first visitor, the predetermined level is set to be lower when the user has the visit history to the target facility than when the user does not have the visit history to the target facility.

14. The information processing method according to claim 12, wherein, when the target facility prioritizes the visit of the second visitor, the predetermined level is set to be higher when the user has the visit history to the target facility than when the user does not have the visit history to the target facility.

15. The information processing method according to claim 12, wherein the specific display is hiding the target facility from a map displayed on the terminal.

16. The information processing method according to claim 12, wherein the specific display is displaying a predetermined display indicating that the target facility is congested.

17. A non-transitory storage medium storing a program that causes a computer to execute an information processing method, the information processing method comprising:
acquiring information on a congestion situation of a target facility;
acquiring information on whether a user has a visit history to the target facility; and
determining a method of displaying the congestion situation of the target facility on a terminal associated with the user based on whose visit the target facility prioritizes between a first visitor who has never visited the target facility and a second visitor who has visited the target facility, the information on whether the user has the visit history to the target facility, and the information on the congestion situation of the target facility.

18. The non-transitory storage medium according to claim 17, wherein, when the target facility prioritizes a visit of the first visitor, in the information processing method, a congestion level of the target facility displayed on the terminal is determined to be higher when the user has the visit history to the target facility than when the user does not have the visit history to the target facility, for the same congestion situation of the target facility.

19. The non-transitory storage medium according to claim 17, wherein, when the target facility prioritizes a visit of the second visitor, in the information processing method, a congestion level of the target facility displayed on the terminal is determined to be lower when the user has the visit history to the target facility than when the user does not have the visit history to the target facility, for the same congestion situation of the target facility.

20. The non-transitory storage medium according to claim 17, wherein:
the information processing method further includes setting a predetermined level based on whose visit the target facility prioritizes between the first visitor and the second visitor, and the information on whether the user has the visit history to the target facility; and
when the congestion situation of the target facility is equal to or higher than the predetermined level, the terminal is determined to execute a specific display on the target facility.
